(19) United States
(12) Patent Application Publication
(10) Pub. No.: US 2017/0039680 A1
(43) Pub. Date: Feb. 9, 2017

(54) DISPLAY CONTROL DEVICE AND METHOD FOR DISPLAYING UI SCREEN ON DISPLAY DEVICE

(71) Applicant: TOSHIBA TEC KABUSHIKI KAISHA, Tokyo (JP)

(72) Inventor: Hiroyuki Abe, Kannami Tagata Shizuoka (JP)

(21) Appl. No.: 15/220,515

(22) Filed: Jul. 27, 2016

(30) Foreign Application Priority Data
Aug. 5, 2015 (JP) 2015-155034

(51) Int. Cl. G06T 3/40; G06F 3/0484

(52) U.S. Cl. CPC G06T 3/40; G06F 3/04847

(57) ABSTRACT

A display control device comprises an acquisition module configured to acquire a screen resolution of a display device; a size change module configured to change a size of an UI screen to a size corresponding to the screen resolution acquired by the acquisition module; and a display control module configured to display the UI screen of which the size is changed by the size change module on the display device.

### CROSS-REFERENCE TO RELATED APPLICATION

This application is based upon and claims the benefit of priority from Japanese Patent Application No. 2015-155034, filed Aug. 5, 2015, the entire contents of which are incorporated herein by reference.

### FIELD

Embodiments described herein relate generally to a display control device and a method for displaying an UI screen on a display device.

### BACKGROUND

Conventionally, in various jobs such as a settlement and the like, a terminal device (dedicated terminal) specialized in the job is used. The dedicated terminal is provided with a display device such as a liquid crystal panel and displays a dedicated UI (User Interface) screen relating to a job on the display device. Further, in the dedicated terminal, the device configuration of the display device is standardized. Thus, in the dedicated terminal, the UI screen with a fixed size corresponding to a screen resolution of the display device is displayed.

Further, in recent years, introduction of an application for job which carries out the display of the foregoing UI screen into a general terminal such as a PC (Personal Computer) or a tablet terminal is carried out. The general terminal executes the application for job to be capable of realizing a function identical to the dedicated terminal.

However, in the general terminal, as the device configuration is not standardized, display devices with various kinds of the screen resolution exist. Thus, in the general terminal, if the foregoing UI screen with the fixed size is displayed on the display device, there is a case in which a margin is generated at the end of a display area or a problem that the UI screen cannot be completely displayed occurs. In this case, as a visibility and an operability of the UI screen are lowered, a technology for enabling the display of an UI screen with a size suitable to the screen resolution of the display device is requested. Further, conventionally, though a technology for displaying information of bargain goods or service information in the margin (unused area) in the display area is proposed, the foregoing problem cannot be solved.

### DESCRIPTION OF THE DRAWINGS

FIG. 1 is a diagram illustrating an example of the hardware structure of a settlement terminal according to an embodiment;

FIG. 2 is a diagram illustrating an example of functional components of the settlement terminal according to the embodiment;

FIG. 3 is a diagram illustrating a UI screen before a size change section shown in FIG. 2 operates;

FIG. 4 is a diagram illustrating a UI screen after the size change section shown in FIG. 2 operates;

FIG. 5 is a diagram illustrating an example of an informing screen; and

FIG. 6 is a flowchart illustrating an example of display control processing carried out by the settlement terminal according to the embodiment.

### DETAILED DESCRIPTION

In accordance with an embodiment, a display control device comprises an acquisition module, a size change module and a display control module. The acquisition module acquires a screen resolution of a display device. The size change module changes a size of an UI screen to a size corresponding to the screen resolution acquired by the acquisition module. The display control module displays the UI screen of which the size is changed by the size change module on the display device.

Hereinafter, a display control device according to the present embodiment is described in detail with reference to the accompanying drawings. The embodiment described below is one embodiment of the display control device, and configuration and specification thereof are not limited. The present embodiment is an application example to a settlement terminal, introduced into a store, which carries out a settlement processing of a transaction.

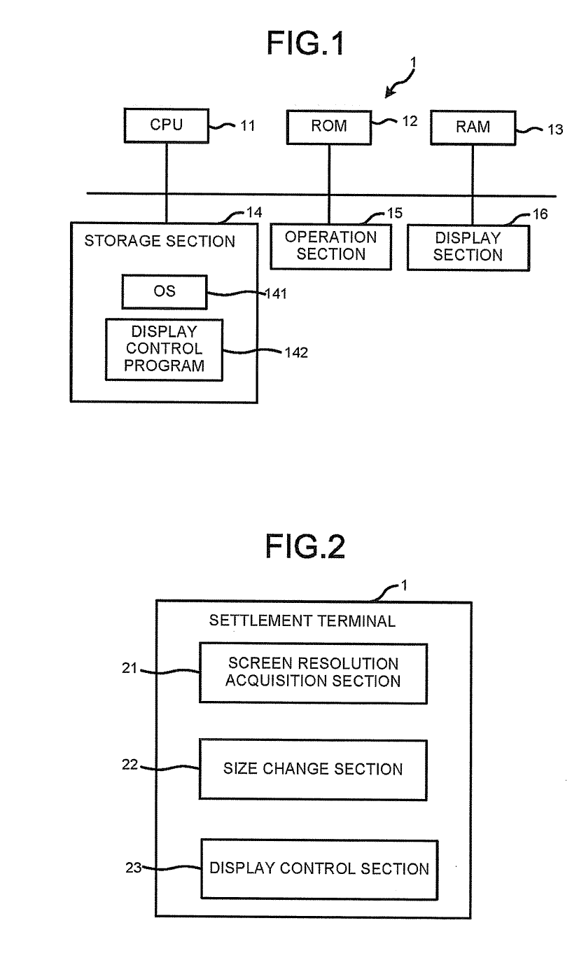

FIG. 1 is a diagram illustrating an example of the hardware structure of a settlement terminal 1 according to the present embodiment. The settlement terminal 1 which is a general terminal such as a PC or a tablet terminal corresponds to the display control device of the present embodiment.

As shown in FIG. 1, the settlement terminal 1 is provided with a CPU (Central Processing Unit) 11, a ROM (Read Only Memory) 12, a RAM (Random Access Memory) 13, a storage section 14, an operation section 15 and a display section 16.

The CPU 11 serving as a processor executes various programs stored in the ROM 12 and the storage section 14 to collectively control operations of each section constituting the settlement terminal 1. The ROM 12 stores various programs which can be executed by the CPU 11 and setting information. The RAM 13 functions as a working memory or a cache memory for the CPU 11.

The storage section 14 which is a storage device such as an HDD (Hard Disk Drive) or an SSD (Solid State Drive) stores various programs which can be executed by the CPU 11 and setting information. For example, the storage section 14 stores an OS (Operating System) 141 of the settlement terminal 1. Further, the storage section 14 stores an UI screen for supporting a settlement processing and a display control program 142 relating to the display of the UI screen. In the present embodiment, the display control program 142 is an application program that operates on the OS 141. Further, the UI screen may be held (built) in the display control program 142.

The operation section 15 is an input device such as a keyboard or a pointing device. The operation section 15 receives an operation of a user and inputs an operation signal corresponding to an operation content to the CPU 11. The display section 16 is a display device such as a liquid crystal panel. The display section 16 displays various kinds of information such as a UI screen under the control of the CPU 11.

The settlement terminal 1 with the foregoing configuration is, for example, the general terminal arranged in the store in the form of a stationary type PC or a tablet terminal. Further, the settlement terminal 1 executes the display control program 142 to realize a function as a settlement terminal that executes the settlement processing of commodities. In a case in which the settlement terminal 1 is the stationary type, the display section 16 may be externally connected with the settlement terminal 1.

Next, functional components of the settlement terminal 1 are described. FIG. 2 is a diagram illustrating an example of the functional components of the settlement terminal 1. As shown in FIG. 2, the settlement terminal 1 is provided with a screen resolution acquisition section 21, a size change section 22 and a display control section 23 as functional sections. These functional sections are realized on the RAM 13 through the cooperation of the CPU 11 and the display control program 142. Further, part or whole of the functional sections may be constructed as the hardware structure realized by a dedicated processor.

The screen resolution acquisition section 21 acquires a screen resolution of the display section 16. No specific limitations are given to an acquisition method of the screen resolution. For example, in a case in which the screen resolution of the display section 16 is already acquired (set) through functions of the OS 141, the screen resolution acquisition section 21 may acquire the screen resolution of the display section 16 from the OS 141.

No specific limitations are given to the screen resolution set by the OS 141 as long as it is within a range of displayable screen resolution of the display section 16. Further, no specific limitations are given to the timing at which the screen resolution acquisition section 21 acquires the screen resolution. For example, the screen resolution acquisition section 21 acquires the screen resolution at the time of starting the settlement terminal 1 or at the time of restoring from the power-saving state. Further, for example, the screen resolution acquisition section 21 acquires the screen resolution at the timing at which the display of the UI screen is instructed.

The size change section 22 changes (magnifies) the size of the UI screen displayed on the display section 16 to a size corresponding to the screen resolution of the display section 16. Further, the display control section 23 cooperates with the size change section 22 to display the UI screen obtained after the size is changed on the display section 16. The UI screen refers to the entire screen on which UI elements such as various operation keys, display areas and the like relating to a settlement job are arranged in advance.

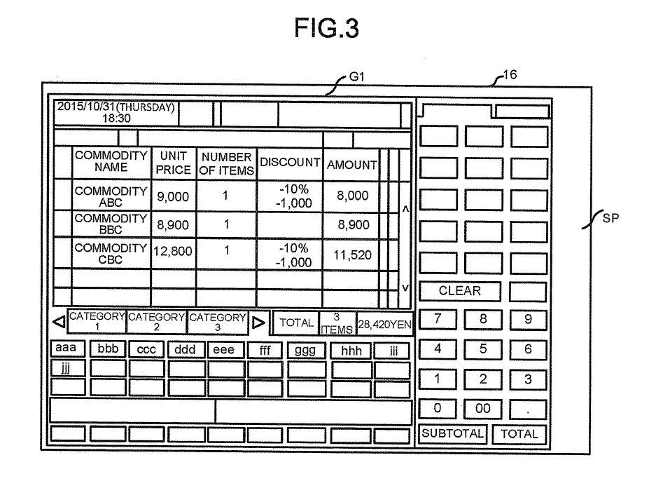

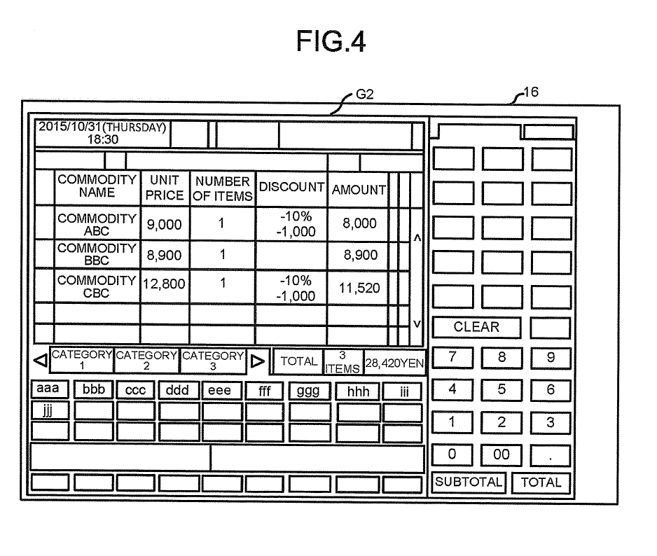

Specifically, the size change section 22 calculates a magnification ratio (change ratio) in length and width directions for setting the size of the UI screen to a size suitable to the screen resolution of the display section 16 on the basis of a ratio of the screen resolution of the display section 16 and the size of the UI screen. Then, the size change section 22 expands or reduces the size of the UI screen in the length and width directions to change the size of the UI screen to the size suitable to the screen resolution of the display section 16 on the basis of the calculated magnification ratio. Hereinafter, with reference to FIG. 3 and FIG. 4, operations of the size change section 22 are described.

FIG. 3 and FIG. 4 are diagrams illustrating a UI screen before and after the size change section 22 operates. For example, in a case in which the screen resolution of the display section 16 is an UltraWideXGA (1600*768), a margin SP is generated at the end-part of the screen as shown in FIG. 3 if an UI screen G1 with a WXGA (1280*768) size is displayed. Thus, the size change section 22 expands the UI screen by 1.25 times in the length direction to change the size of the UI screen to the size suitable to the UltraWideXGA. The changed UI screen G2 is displayed to the end of the display section 16 at which the margin SP is displayed, as shown in FIG. 4. In this way, the visibility and the operability of the UI screen can be improved. If it is determined that the size of the UI screen is coincident with the screen resolution of the display section 16, the size change section 22 outputs the UI screen to the display control section 23 as it is (without changing the size).

Further, the size of the UI screen stored in the storage section 14 is not limited to one. For example, the storage section 14 may hold a plurality of UI screens of which sizes are different from each other. In this case, the size change section 22 selects an UI screen with a size coincident with the screen resolution of the display section 16 from a plurality of the UI screens. In a case in which there is no coincident UI screen, the size change section 22 selects an UI screen with a size closest to the screen resolution of the display section 16. Then, the size change section 22 expands or reduces the selected UI screen to change the size of the UI screen to the size suitable to the screen resolution of the display section 16.

Further, in a case in which the magnification ratio of the UI screen is equal to or greater than a predetermined threshold value, the size change section 22 functions as an informing module for carrying out an informing operation. For example, in a case in which the magnification ratio of the UI screen becomes a value at which a possibility that the reduction of the visibility and the operability is caused exists, the size change section 22 displays an informing screen that instructs the change of the screen resolution on the display section 16.

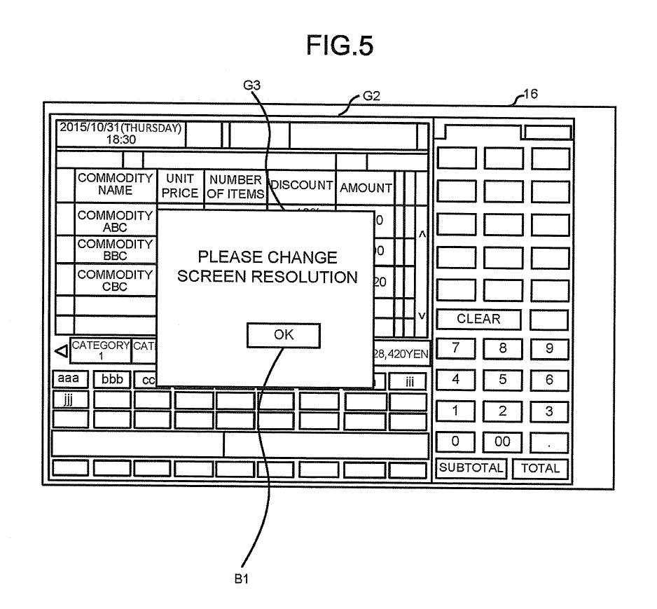

FIG. 5 is a diagram illustrating an example of the informing screen. In FIG. 5, a screen for displaying a message that instructs the change of the screen resolution is exemplified as an informing screen G3. An OK button B1 is an operator for instructing an erasure of the informing screen G3. In this way, in the settlement terminal 1 of the present embodiment, in a case in which there is a possibility that the visibility and the operability are reduced due to the magnification of the UI screen, the reduction of the visibility and the operability can be informed to the user, and thus the convenience can be improved.

Further, in FIG. 5, it is exemplified that the UI screen G2 on which the size change is executed is displayed together with the informing screen G3; however, the display form is not limited to this. For example, the size change section 22 may display the UI screen (for example, the UI screen G1) on which the size change is not performed together with the informing screen G3. Further, for example, the size change section 22 may display only the informing screen G3 but not the UI screen.

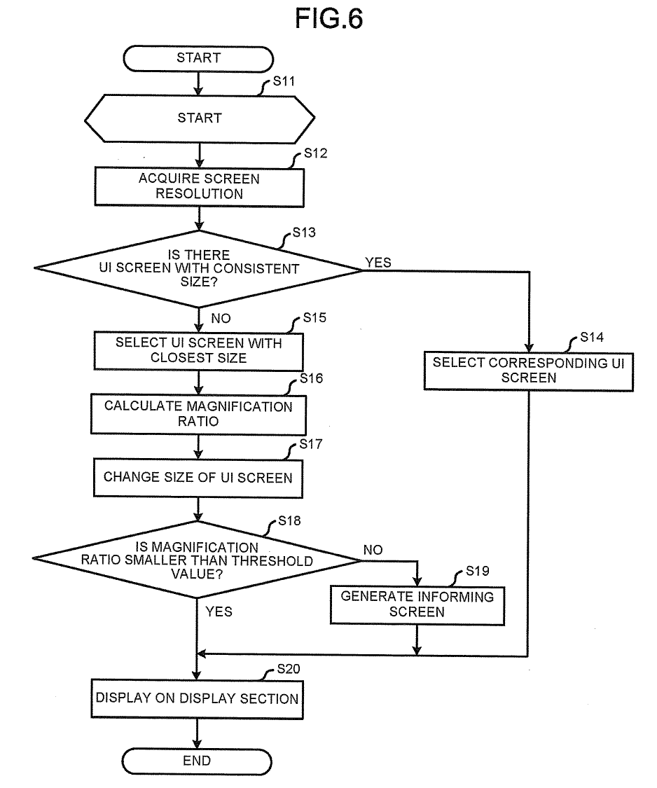

Next, with reference to FIG. 6, a display control processing relating to the display of the UI screen is described. FIG. 6 is a flowchart illustrating an example of the display control processing carried out by the settlement terminal 1. In the present processing, a case of carrying out the acquisition of the screen resolution at the time of staring the settlement terminal 1 is described. Further, in the present processing, a case of selectively using one UI screen from a plurality of the UI screens is described.

First, the settlement terminal 1 is started through an operation such as turning on power supply (Act S11). The CPU 11 starts the OS 141 stored in the storage section 14 along with the start of the settlement terminal 1. After starting the OS 141, the CPU 11 further starts the display control program 142 stored in the storage section 14 to realize the foregoing functional sections on the RAM 13.

The screen resolution acquisition section 21 acquires the screen resolution of the display section 16 (Act S12). Next, the size change section 22 determines whether or not there is an UI screen of which the size is coincident with the screen resolution acquired in Act S12 (Act S13). If it is determined in Act S13 that there is the UI screen (Yes in Act S13), the size change section 22 selects the target UI screen (Act S14) and proceeds to the processing in Act S20.

On the other hand, if it is determined in Act S13 that there is no UI screen (No in Act S13), the size change section 22 selects an UI screen with a size closest to the screen resolution acquired in Act S12 (Act S15). The size change section 22 calculates the magnification ratio of the UI screen on the basis of the screen resolution acquired in Act S12 and the size of the UI screen selected in Act S15 (Act S16). Next, the size change section 22 changes the size of the UI screen on the basis of the magnification ratio calculated in Act S16 (Act S17).

Subsequently, the size change section 22 determines whether or not the magnification ratio calculated in Act S16 is smaller than the threshold value (Act S18) If it is determined that the magnification ratio is smaller than the threshold value (Yes in Act S18) , the size change section 22 immediately proceeds to the processing in Act S20. On the other hand, if it is determined that the magnification ratio is equal to or greater than the threshold value (No in Act S18), the size change section 22 generates the informing screen (Act S19) and proceeds to the processing in Act S20.

The display control section 23 displays the UI screen selected in Act S14 or the UI screen of which the size is changed in Act S17 on the display section 16 (Act S20) and terminates the processing. In a case in which the informing screen is generated in Act S19, the display control section 23 displays the informing screen on the UI screen.

As stated above, the settlement terminal 1 acquires the screen resolution of the display section 16, changes (magnifies) the size of the UI screen to the size corresponding to the screen resolution and displays the UI screen on the display section 16. In this way, in the settlement terminal 1, the UI screen with the size suitable to the screen resolution of the display section 16 can be displayed, and thus the visibility and the operability of the UI screen can be improved.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, in the foregoing embodiment, the size of the UI screen can be magnified in the length and width directions; however, the present embodiment is not limited to this, and it may be possible to magnify the size of the UI screen in either of the length and width directions.

Further, the magnification ratio of the length and width directions may be replaced according to the orientation of the display section 16. Specifically, in the tablet terminal, the screen display is switched to the width direction or the length direction according to the orientation of a main body. Thus, for such a tablet terminal, by replacing the magnification ratio of the length and width directions according to the orientation of the main body (display section 16), the screen display can be switched correspondingly.

What is claimed is:

1. A display control device, comprising:
an acquisition module configured to acquire a screen resolution of a display device;
a size change module configured to change a size of an UI screen to a size corresponding to the screen resolution acquired by the acquisition module; and
a display control module configured to display the UI screen of which the size is changed by the size change module on the display device.

2. The display control device according to claim 1, wherein the size change module changes an UI screen with a size closest to the acquired screen resolution from a plurality of UI screens with different sizes to the UI screen with a size corresponding to the screen resolution.

3. The display control device according to claim 1, wherein the size change module selects the UI screen in a case in which the size of the UI screen is coincident with the screen resolution, and the display control module displays the UI screen selected by the size change module on the display device.

4. The display control device according to claim 2, wherein the size change module selects the UI screen in a case in which the size of the UI screen is coincident with the screen resolution, and the display control module displays the UI screen selected by the size change module on the display device.

5. The display control device according to claim 1, further comprising an informing module configured to carry out an informing operation in a case in which a change ratio of the UI screen is equal to or greater than a predetermined threshold value.

6. The display control device according to claim 1, wherein the acquisition module acquires the screen resolution from an operating system.

7. A method for displaying an UI screen on a display device, including:
acquiring a screen resolution of the display device;
changing a size of the UI screen to a size corresponding to the screen resolution of the display device; and
displaying the UI screen of which the size is changed on the display device.
